(19) United States
(12) Patent Application Publication
(10) Pub. No.: US 2016/0117415 A1
(43) Pub. Date: Apr. 28, 2016

(54) METHOD AND SYSTEM TO DISCOVER DEPENDENCIES IN DATASETS

(71) Applicants: Jorge Arnulfo QUIANÉ RUIZ, Doha (QA); Felix NAUMANN, Doha (QA); Arvid HEISE, Potsdam (DE)

(72) Inventors: Jorge Arnulfo Quiané Ruiz, Doha (QA); Felix Naumann, Doha (QA); Arvid Heise, Potsdam (DE)

(21) Appl. No.: 14/894,507

(22) PCT Filed: Jul. 10, 2013
(86) PCT No.: PCT/EP2013/064633

§ 371 Date: Nov. 28, 2015

(30) Foreign Application Priority Data
May 31, 2013 (GB) 1309796.9
Jun. 3, 2013 (GB) 1309861.1

(51) Int. Cl. G06F 17/30

(52) U.S. Cl. CPC G06F 17/30958; G06F 17/30917

(57) ABSTRACT

A method of processing data stored in a database which comprises a plurality of rows and columns, the method comprising identifying a plurality of sets of column combinations, each set of column combinations comprising an identifier of at least one column allocating each set of column combinations to one of a plurality of nodes mapping the nodes to a lattice structure in which the nodes are connected in a superset or subset relationship according to the set of column combinations of each node selecting a current node processing the data in the set of columns of the current node to detect if the column combination is unique or non-unique traversing the lattice to a next node which is connected to the current node processing the data in the set of columns of the next node to detect if the column combination of the next node is unique or non-unique; and storing a record of whether each processed set of column combinations is unique or non-unique.

The present invention relates to a method and system for analyzing data, and more particularly relates to a method and system for discovering unique column combinations.

We are in a digital era where many emerging applications (e.g., from social networks to scientific domains) produce huge amounts of data that outgrow our current data processing capacities. These emerging applications produce very large datasets not only in terms of the number of rows, but also in terms of the number of columns. Thus, understanding such datasets before actually querying them is crucial for ensuring both data quality and query performance.

Data profiling is the activity of discovering and understanding relevant properties of datasets. One important task of data profiling is to discover unique column combinations (uniques for short) and non-unique column combinations (non-uniques). A unique is a set of columns whose projection has no duplicates. Knowing all uniques and non-uniques helps understand the structure and the properties of the data. Uniques and non-uniques are useful in several areas of data management, such as anomaly detection, data integration, data modelling, duplicate detection, indexing, and query optimization. For instance, in databases, uniques are primary key candidates.

However, many uniques and non-uniques are unknown and hence have to be discovered. The research and industrial communities have paid relatively little attention to the problem of finding uniques and non-uniques. Perhaps this lack is due to the nature of this problem: the number of possible column combinations to be analyzed is exponential in the number of attributes. For instance, a brute-force approach would have to enumerate 2⁹⁴−1 column combinations to find all uniques and non-uniques in a dataset with 94 attributes. Performing this enumeration is infeasible in practice. As a result, commercial products limit the search space to column combinations with only few columns. This restriction loses the insights that long uniques and non-uniques (i.e., those with many attributes) can offer. For example, in bioinformatics, long uniques might lead to the detection of unknown principles between protein and illness origins. Long non-uniques might lead to the detection of surprising partial duplicates (i.e., rows having duplicate values in many attributes) in a relation.

Assessing and integrating many data sources is a difficult task that requires fast data analysis. In the life sciences domain, integrating datasets on genes, proteins, targets, diseases, drugs, and patients helps to discover and develop drugs. The amount of publicly available data that is relevant for this task has grown significantly in recent years. Thus, scientists need new, more efficient ways to discover and understand datasets from different data sources.

Existing work has focused on providing efficient techniques to discover uniques. For example, Gordian pre-organizes the data of a relation into a prefix tree and discovers maximal non-uniques by traversing the prefix tree. This technique is disclosed in: Y. Sismanis, P. Brown, P. J. Haas, and B. Reinwald. Gordian: efficient and scalable discovery of composite keys. In Proceedings of the International Conference on Very Large Databases (VLDB), pages 691-702, 2006.

Giannella and Wyss propose a technique that is based on the apriori intuition, which says that supersets of already discovered uniques and subsets of discovered non-uniques can be pruned from further analysis. This technique is disclosed in: C. Giannella and C. Wyss. Finding minimal keys in a relation instance.

http://http://citeseerx.ist.psu.edu/viewdoc/summary?doi=10.1.1.41.7086.

HCA discovers uniques based on histograms and value-counting. This technique is disclosed in: Z. Abedjan and F. Naumann. Advancing the discovery of unique column combinations. In Proceedings of the International Conference on Information and Knowledge Management (CIKM), pages 1565-1570, 2011.

However, none of the above prior art techniques have been designed with very large datasets in mind and hence they scale poorly with the number of rows and/or the number of columns.

The present invention seeks to provide an improved method and system for processing data.

According to one aspect of the present intention there is provided a method of processing data stored in a database which comprises a plurality of rows and columns, the method comprising: A) identifying a plurality of sets of column combinations, each set of column combinations comprising an identifier of at least one column; B) allocating each set of column combinations to one of a plurality of nodes; C) mapping the nodes to a lattice structure in which the nodes are connected in a superset or subset relationship according to the set of column combinations of each node; D) selecting a current node; E) processing the data in the set of columns of the current node to detect if the column combination is unique or non-unique; F) traversing the lattice to a next node which is connected to the current node; G) processing the data in the set of columns of the next node to detect if the column combination of the next node is unique or non-unique; and H) storing a record of whether each processed set of column combinations is unique or non-unique.

Preferably, the method further comprises setting the next node as the current node and repeating steps F to H for at least one further iteration.

Conveniently, storing step H comprises only storing a record of either unique or non-unique sets of column combinations.

Advantageously, the method further comprises determining a group of sets of non-unique column combinations by subtracting the sets of unique column combinations from the total number of column combinations.

Preferably, the method further comprises determining a group of sets of unique column combinations by subtracting the sets of non-unique column combinations from the total number of column combinations.

Conveniently, the method further comprises recording a list of duplicate values in each column combination in a position list index (PLI).

Advantageously, the method further comprises searching the PLI for the set of column combinations of a node before processing the data in the set of columns.

Preferably, if the set of column combinations is detected in the PLI, recording the set of column combinations as a non-unique set of column combinations and traversing to the next node in the lattice without processing the data in the set of columns of the current node.

Conveniently, the method further comprises storing in a graph data structure, for a selected column, a list of sets of unique column combinations and sets of non-unique column combinations containing the selected column.

Advantageously, the method further comprises searching the graph data structure for the set of column combinations of a node before processing the data in the set of column combinations to determine if a set of column combinations is a superset or subset of a set of column combinations which was previously determined to be unique or non-unique.

Preferably, the method further comprises recording in a path trace data structure the path in which the lattice is traversed.

Conveniently, the method further comprises receiving a user input traversal parameter and the step of traversing the lattice is performed in accordance with the user input traversal parameter.

Advantageously, steps of the method are performed using a plurality of central processing unit (CPU) cores.

Preferably, steps of the method are performed by multiple worker modules with at least two worker modules executing on separate CPU cores, and wherein each worker module stores a local copy of all unique and non-unique sets of column combinations which have been already detected by the other worker modules.

Conveniently, the method comprises communicating detection information between the worker modules via a shared local event bus.

Advantageously, steps of the method are performed on separate computer nodes in a network of computer nodes.

Preferably, the method comprises recording any null values in the data as duplicates.

Conveniently, the method further comprises initially estimating the distinctness of the sets of column combinations of each node and selecting the node having the set of column combinations with the highest distinctness as the initial current node.

Advantageously, the method comprises traversing the lattice in a first direction until a node is identified with a unique set of column combinations and then traversing the lattice in a second direction until a node is detected with a non-unique set of column combinations.

Preferably, the method comprises repeating for a plurality of iterations the traversal of the lattice in the first and second directions.

According to another aspect of the present invention, there is provided a system for processing a system for processing data stored in a database which comprises a plurality of rows and columns, the system comprising: A) an identification module operable to identifying a plurality of sets of column combinations, each set of column combinations comprising an identifier of at least one column; B) an allocation module operable to allocate each set of column combinations to one of a plurality of nodes; C) a mapping module operable to map the nodes to a lattice structure in which the nodes are connected in a superset or subset relationship according to the set of column combinations of each node; D) a selection module operable to select a current node; E) a processing module operable to process the data in the set of columns of the current node to detect if the column combination is unique or non-unique; F) a traversal module operable to traverse the lattice to a next node which is connected to the current node; G) a further processing module operable to process the data in the set of columns of the next node to detect if the column combination of the next node is unique or non-unique; and H) a memory operable to store a record of whether each processed set of column combinations is unique or non-unique.

Preferably, the system is operable to set the next node as the current node and operate the modules F to H for at least one further iteration.

Conveniently, the storing module H is operable to only store a record of either unique or non-unique sets of column combinations.

Advantageously, the system is operable to determine a group of sets of non-unique column combinations by subtracting the sets of unique column combinations from the total number of column combinations.

Preferably, the system is operable to determine a group of sets of unique column combinations by subtracting the sets of non-unique column combinations from the total number of column combinations.

Conveniently, the system is operable to record a list of duplicate values in each column combination in a position list index (PLI).

Advantageously, the system is operable to search the PLI for the set of column combinations of a node before processing the data in the set of columns.

Preferably, if the set of column combinations is detected in the PLI, system is operable to record the set of column combinations as a non-unique set of column combinations and traversing to the next node in the lattice without processing the data in the set of columns of the current node.

Conveniently, the system is operable to store in a graph data structure, for a selected column, a list of sets of unique column combinations and sets of non-unique column combinations containing the selected column.

Advantageously, the system is operable to searching the graph data structure for the set of column combinations of a node before processing the data in the set of column combinations to determine if a set of column combinations is a superset or subset of a set of column combinations which was previously determined to be unique or non-unique.

Preferably, the system is operable to record in a path trace data structure the path in which the lattice is traversed.

Conveniently, the system is operable to receive a user input traversal parameter and the step of traversing the lattice is performed in accordance with the user input traversal parameter.

Advantageously, the system incorporates steps of a plurality of central processing unit (CPU) cores.

Preferably, the system incorporates multiple worker modules at least two of the worker modules are operable to execute on separate CPU cores, and wherein each worker module is operable to store a local copy of all unique and non-unique sets of column combinations which have been already detected by the other worker modules.

Conveniently, the system is operable to communicate detection information between the worker modules via a shared local event bus.

Advantageously, the system incorporates separate computer nodes in a network of computer nodes.

Preferably, the system is operable to record any null values in the data as duplicates.

Conveniently, the system is operable to initially estimate the distinctness of the sets of column combinations of each node and select the node having the set of column combinations with the highest distinctness as the initial current node.

Advantageously, the system is operable to traverse the lattice in a first direction until a node is identified with a unique set of column combinations and then traverse the lattice in a second direction until a node is detected with a non-unique set of column combinations.

Preferably, the system is operable to repeat for a plurality of iterations the traversal of the lattice in the first and second directions.

In order that the invention may be more readily understood, and so that further features thereof may be appreciated, embodiments of the invention will now be described, by way of example, with reference to the accompanying drawings in which:

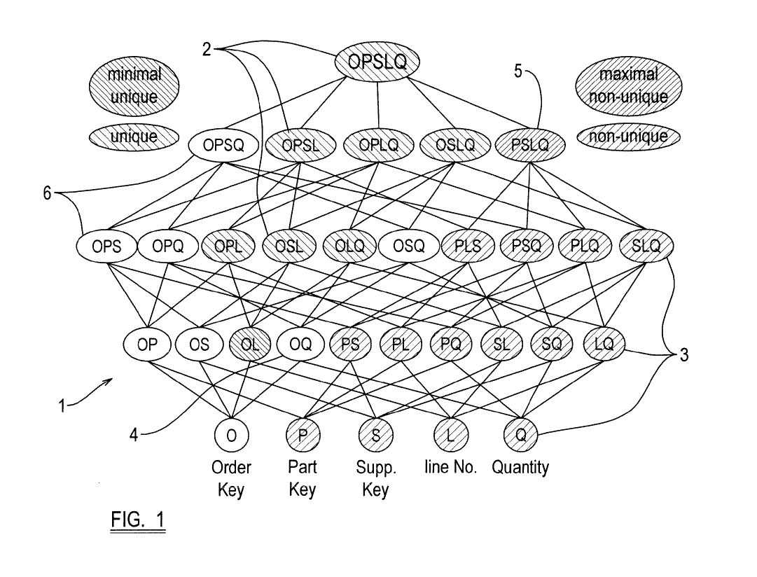

FIG. 1 is a schematic diagram showing the effects of pruning in a lattice,

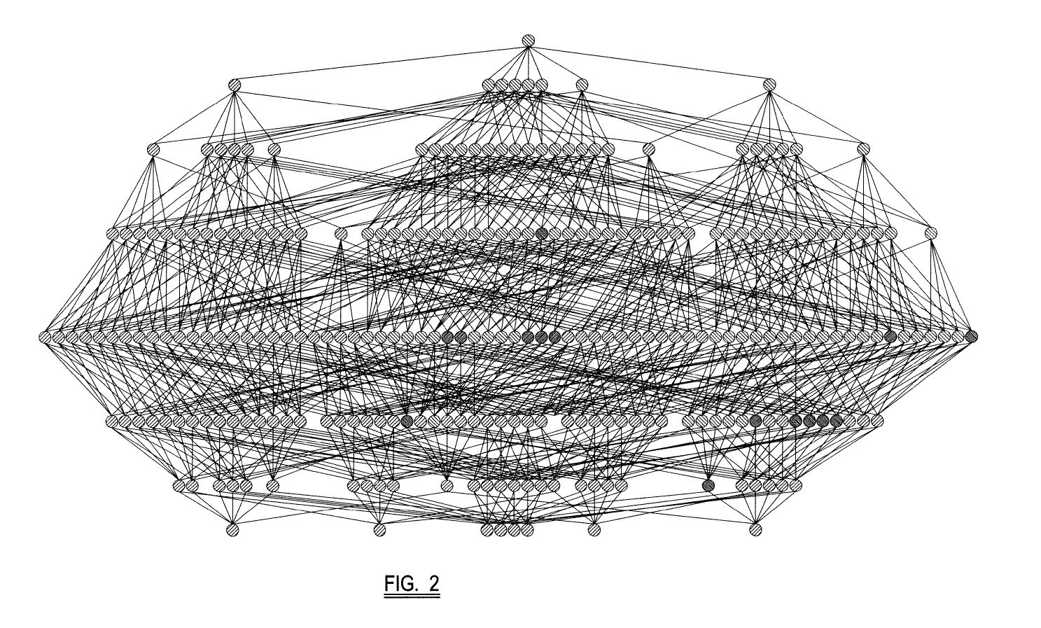

FIG. 2 is a schematic diagram showing the effects of pruning in eight columns of a TPCH line-item lattice,

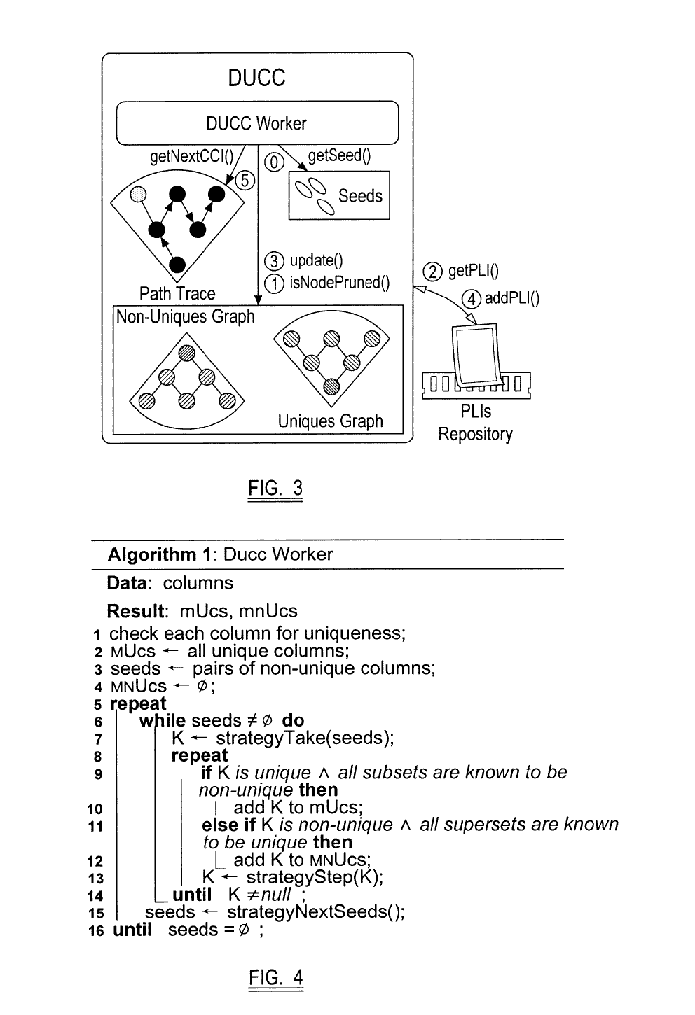

FIG. 3 is a schematic diagram of the architecture of the Ducc worker,

FIG. 4 shows Algorithm 1 implemented in the Ducc worker,

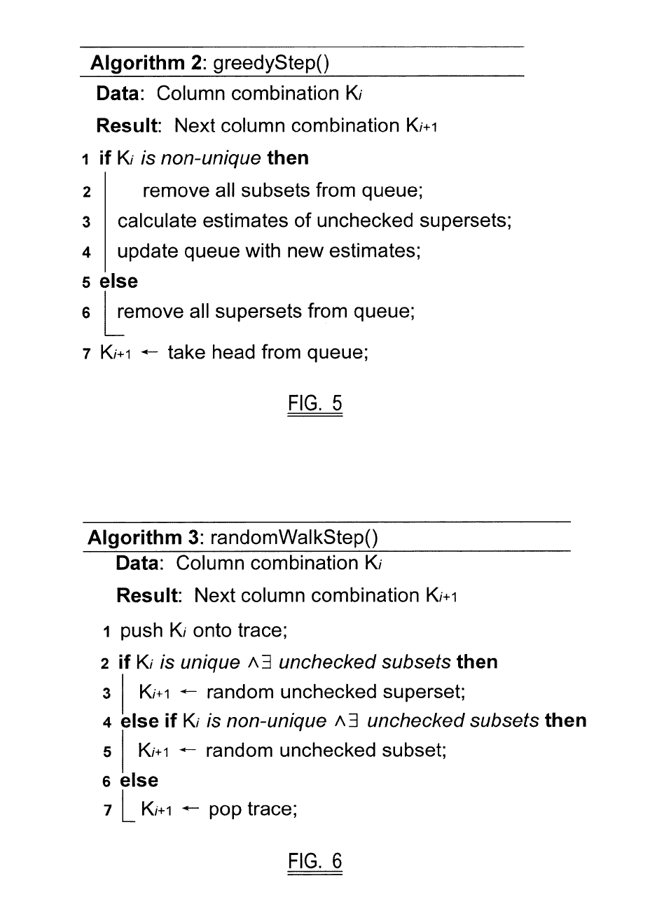

FIG. 5 shows the implementation of the Greedy strategy in Algorithm 2,

FIG. 6 shows the Random Walk strategy implemented in Algorithm 3,

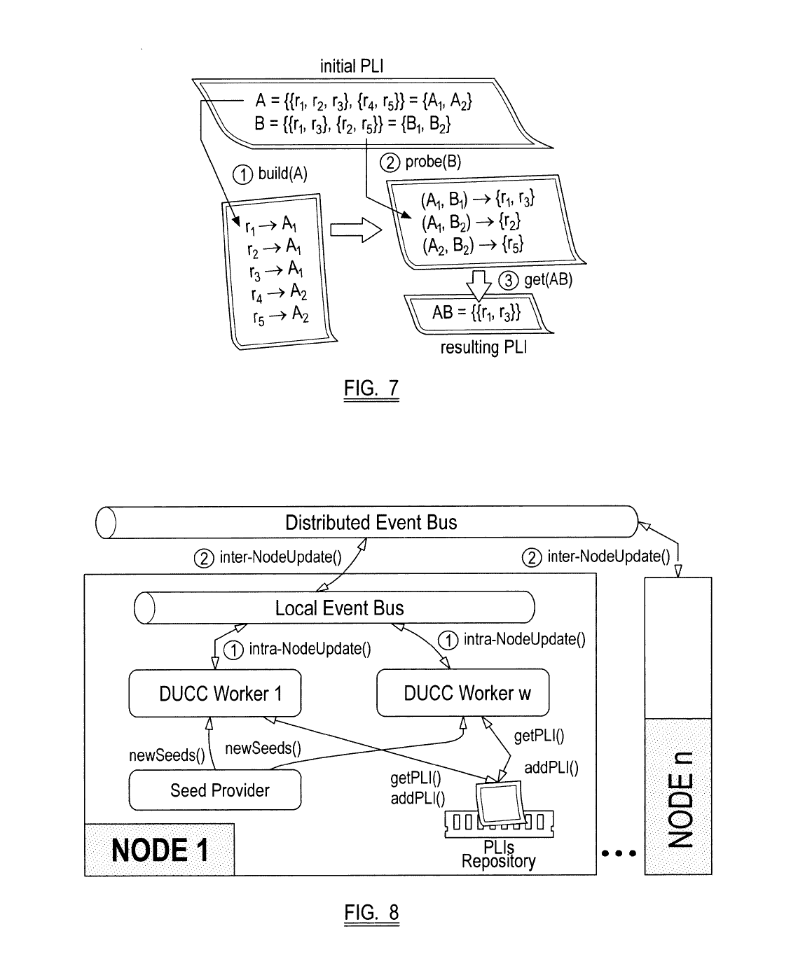

FIG. 7 is a schematic diagram showing an example of two intersecting position list indexes,

FIG. 8 is a schematic diagram of the distributed Ducc architecture,

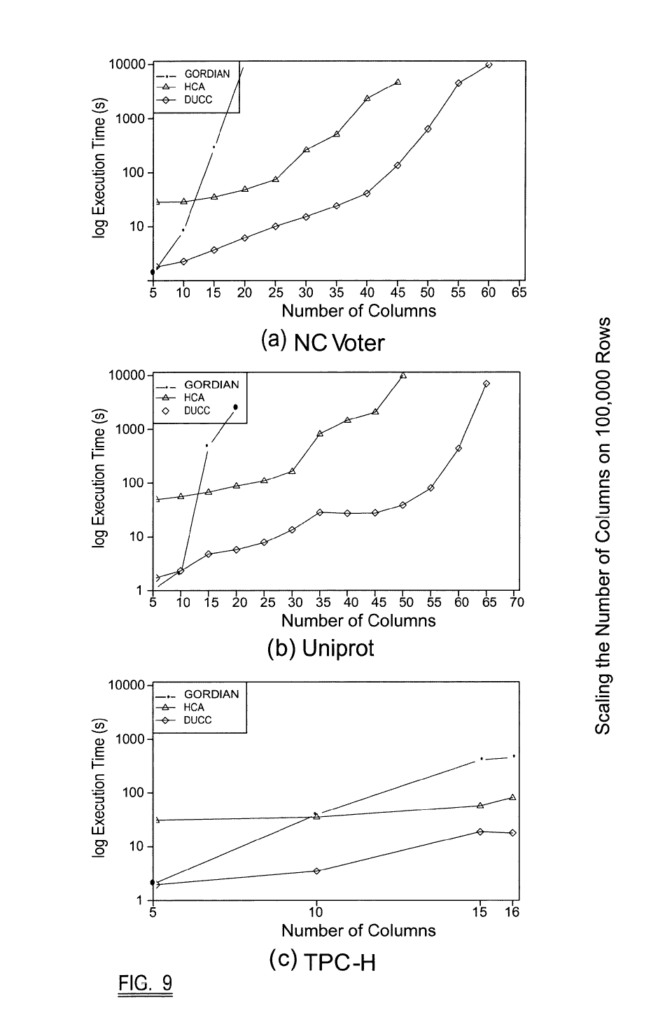

FIGS. 9(a-c) are graphical representations of the results of column scaling experiments,

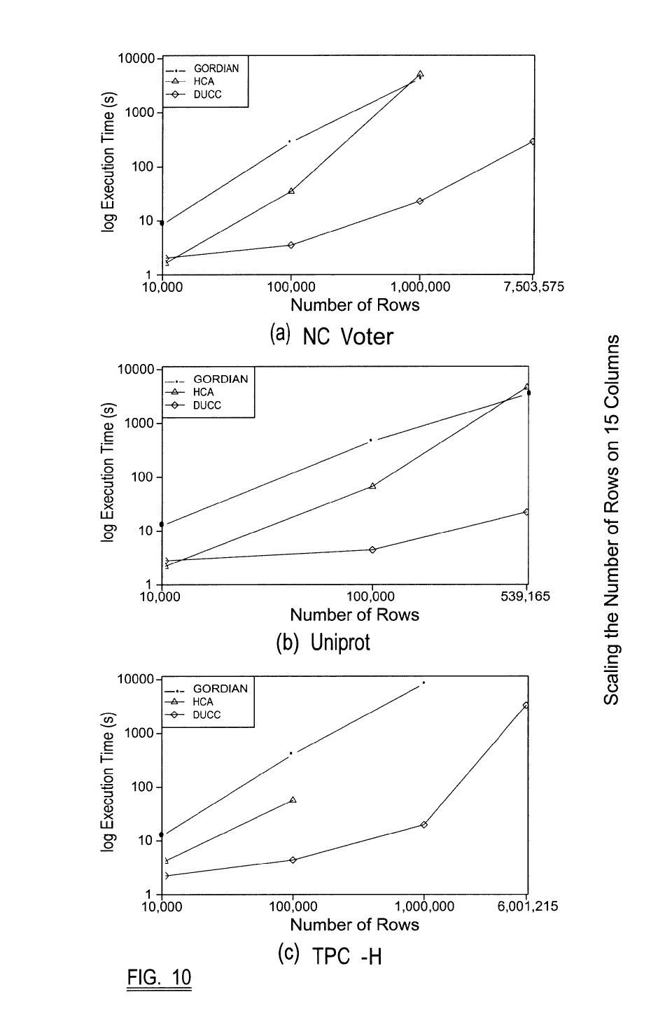

FIGS. 10(a-c) are graphical representations of the results of row scaling experiments,

FIG. 11 is a graphical representation of the correlation analysis of mUcs and uniqueness checks,

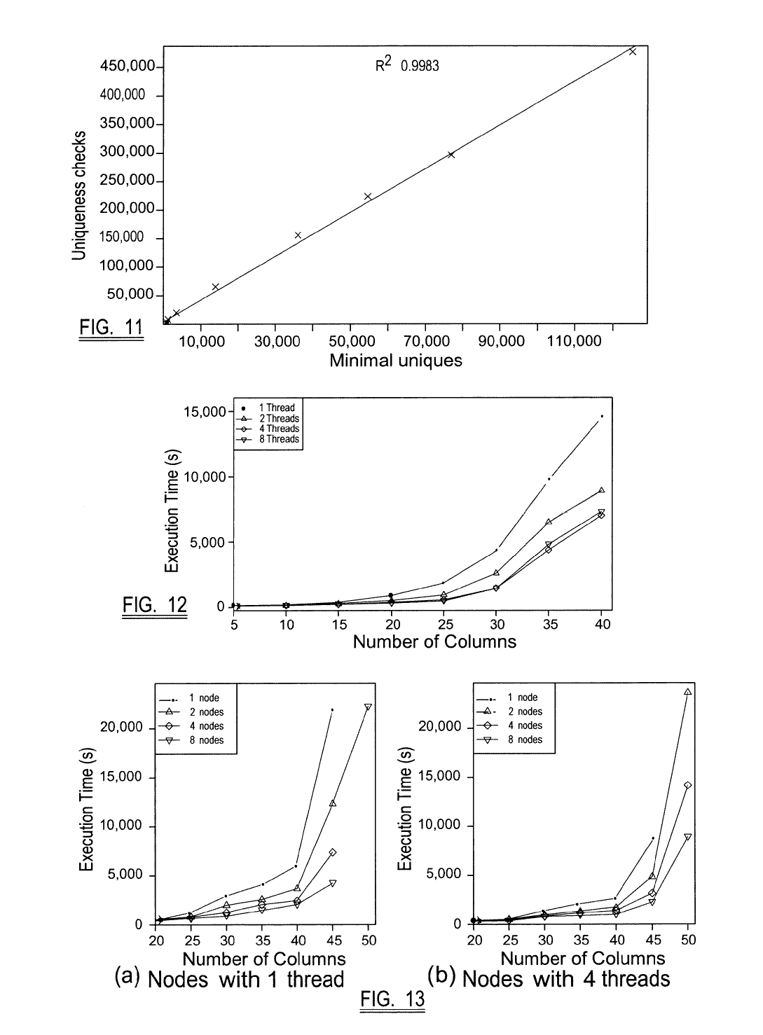

FIG. 12 is a graphical representation of the scale-up of an example NCVoter dataset,

FIGS. 13(a-b) are graphical representations of the scale-out of the example NCVoter dataset,

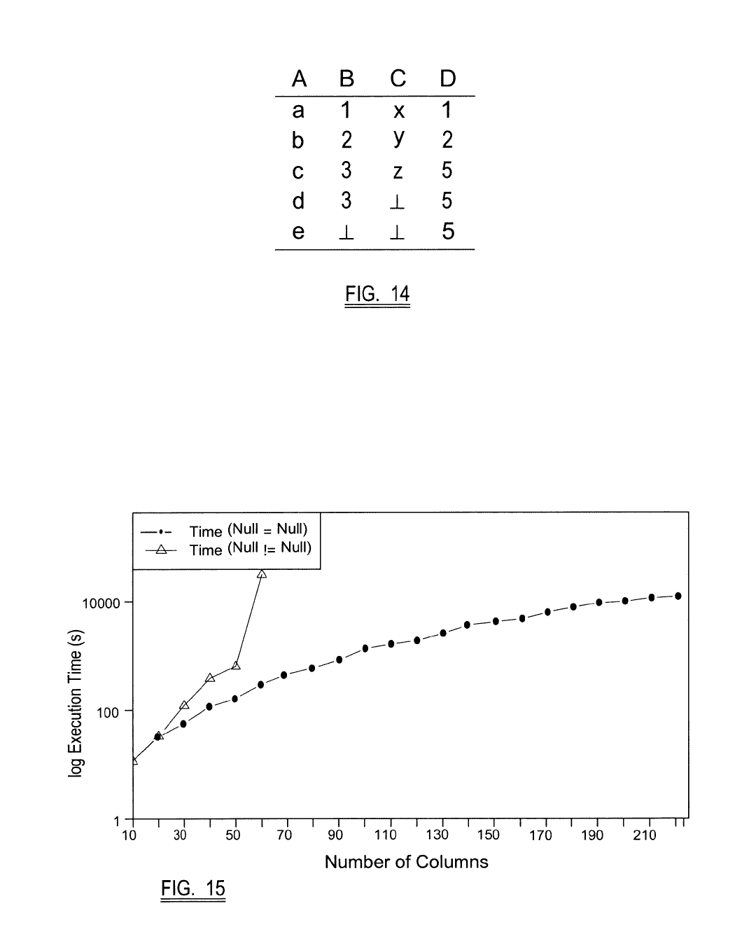

FIG. 14 shows Table 1 which represents example relationships for different null-value semantics, and

FIG. 15 is a graphical representation of a comparison of the null semantics in the Uniprot dataset.

### 1. INTRODUCTION

### Research Challenges

Discovering all (non-)uniques is an NP-Hard problem, which makes their discovery in very large datasets challenging:

(1) Enumerating all column combinations is infeasible in practice, because the search space is exponential in the number of columns. Thus, one must apply effective and aggressive pruning techniques to find a solution set in reasonable time.

(2) The solution space can also be exponential: the number of uniques might reach

$$( \begin{matrix}n \\ n / 2\end{matrix} ) ,$$

where n is the number of columns. There can be no polynomial solution in such cases.

(3) Parallel and distributed approaches are a natural choice in such settings. However, they require exchanging a large number of messages among the processes to avoid redundant work. Thus, achieving scalability in this context is a tremendous challenge by itself.

Contributions and Structure of this Work.

We address the problem of efficiently finding all uniques and non-uniques in big datasets as follows:

(1) We first model the problem of finding all uniques and non-uniques as a graph processing problem. In particular, we show that either the set of uniques or non-uniques is a summary of the complete lattice. Hence, one can build the set of non-uniques from the set of uniques and vice-versa (Section 2).

(2) We then present Ducc, an efficient and scalable system for Discovering (non)UniqueColumn Combinations in big datasets. In particular, we propose a new hybrid graph traversal algorithm that combines the depth-first and random walk strategies. One can use this hybrid graph strategy to traverse the lattice in a bottom-up or top-down manner (or both at the same time). The main idea behind this new algorithm is to quickly reach and follow the “border” that separates uniques from non-uniques in the lattice in order to prune large swaths of the lattice. We also propose a set of light-weight data structures that enable Ducc to perform uniqueness checks in only a few milliseconds as well as to significantly reduce its memory footprint (Section 3).

(3) Since Ducc makes use of aggressive pruning techniques (especially when running in a distributed environment), it might create some holes in the lattice, i.e., it may make some column combinations unreachable. We propose a technique to find and remove such holes from the lattice and formally prove that Ducc computes the correct and complete set of uniques and non-uniques (Section 4).

(4) Next, we present a general inter-process communication protocol to scale Ducc both up and out. Since this communication protocol is lock-free and fully asynchronous, it allows Ducc to scale with a very low synchronisation overhead. Ducc uses Hadoop (hadoop.apache.org) to scale out to multiple computing nodes and Kafka (kafka.apache.org) to communicate among computing nodes. In particular, Ducc uses a selective communication mechanism to reduce the network traffic across computing nodes (Section 5).

(5) We experimentally validate Ducc and compare it with two baseline systems: Gordian and HCA. We use two real datasets (NCVoter and UniProt) and one synthetic dataset (TPC-H) in our evaluation. The results show the high superiority of Ducc over state-of-the-art: Ducc is up to 2.8 orders of magnitude faster than Gordian and up to 2.6 orders of magnitude faster than HCA. Scalability experiments also show the superiority of Ducc when increasing the dataset size (Section 6). We also discuss how different null value semantics impact the performance of Ducc (Section 7).

### 2. PROBLEM STATEMENT

We define the basic concepts of unique column combinations and proceed to state the problem solved by a preferred embodiment of the invention. Given a relation R with schema S (the set of n attributes) a unique column combination is a set of one or more attributes whose projection has only unique rows. In turn, a non-unique column combination has at least one duplicate row.

### DEFINITION 1

### (Non-)Unique Column Combination

A column combination K⊂S is a unique, iff ∀rᵢ, εR, i≠j: rᵢ[K]≠rⱼ[K]. All other column combinations are non-unique.

We denote the set of (non-)unique column combinations as (n)Uc. Obviously, any superset of a unique is also unique and any subset of a non-unique is also non-unique. Thus, the most interesting uniques are those that are not supersets of other uniques. We call these uniques minimal uniques and denote their set mUcs. In analogy, we are also interested in the maximal non-uniques (mnUcs). Notice that a minimal unique is not necessarily the smallest unique and vice versa for maximal non-uniques. We formally define a minimal unique in Definition 2 and a maximal non-unique in Definition 3.

### DEFINITION 2

### Minimal Unique Column Combination

A unique K⊂S is minimal iff
∀K′⊂K:(∃rᵢ, rⱼεR, i≠j:rᵢ[K′]≠rⱼ[K′])

### DEFINITION 3

### Maximal Non-Unique Column Combination

A non-unique K⊂S is maximal iff
∀K′⊃K:(∃rᵢ, rⱼεR, i≠j:rᵢ[K′]≠rⱼ[K′])

Finding a single minimal unique is solvable in polynomial time: Simply start by checking the combination of all attributes and recursively remove attributes from combinations in a depth-first manner until all removals from a given unique render it non-unique. The number of nodes explored in this manner is Σᵢ₌₀ⁿ⁻¹(n−i)=O(n²).

Remember that n denotes the number of attributes. However, the problem we want to solve in this paper is to discover all minimal uniques and all maximal non-uniques in a given relation. A naïve approach would have to check all 2ⁿ−1 non-empty column combinations. Each check then involves reading all rows searching for duplicates. Clearly, this approach is intractable. In fact, in the worst case, there can be up to

$$( \begin{matrix}n \\ n / 2\end{matrix} ) \geq {2}^{\frac{n}{2}}$$

minimal uniques, so the solution space is already exponential. Furthermore, it has been shown that the problem of finding the number of all uniques or all minimal uniques of a given database is #P-hard.

In an embodiment of the invention, we model the search space as a lattice of all column combinations. FIG. 1 shows a lattice 1 of column combinations for the first 5 attributes from TPC-H lineitem. Each node corresponds to a column combination and nodes that are in a sub/superset relationship are connected. We use discovered uniques 2 and non-uniques 3 to prune this lattice. We have exemplarily marked the discovery of OL (OrderKey and Lineitem) as minimal unique 4 and PSLQ (PartKey, SupplyKey, Lineitem, and Quantity) as maximal non-unique 5. Both discoveries result in a significant pruning of the lattice 1 leaving only eight further nodes 6 of the thirty one nodes to be checked. Again, any discovery within the eight remaining nodes leads us to further pruning. A larger example lattice 7 is shown in FIG. 2. The lattice 7 was created from the first eight columns of an instance of the TPC-H lineitem table with a scale factor of 0.01. This larger example lattice 7 shows the complexity of the problem that occurs already for a relatively small number of columns where there are several uniques to be discovered.

In general, minimal uniques at the bottom and maximal non-uniques at the top of the lattice lead to larger sets of nodes that we can prune. However, minimal uniques are more likely to be discovered higher up in the lattice, because more columns make uniqueness more likely. And vice versa, maximal non-uniques are more likely to be found in the lower part of the lattice, because there is a higher chance of duplicates in a fewer number of columns. Thus, one of the main challenges to find all minimal uniques and all maximal non-uniques is to efficiently choose the most effective nodes to check first, keeping in mind the huge size of the lattice for real-world datasets.

### 3. THE DUCC SYSTEM

Ducc is a system of an embodiment of the invention for finding unique and non-unique column combinations in big datasets. For simplicity, we assume for now that Ducc is a single-thread process running on a single node. We relax this assumption in Section 5, where we discuss how Ducc scales up to several CPU cores and scales out to multiple nodes.

3.1 Overview

FIG. 3 illustrates the general architecture of Ducc. Ducc is composed of a Ducc worker (or worker, for short) that orchestrates the unique discovery process and a set of lightweight data structures (position list index (PLI), (non-)uniques graph, and path trace, explained later). Overall, Ducc first computes a PLI for each attribute in the input dataset. The PLI of a given attribute (or column combination) is a list of sets of tuple-ids having the same value for the given column (or column combination).

Then, Ducc operates as follows: The Ducc worker first fetches a seed (i.e., an initial column combination) from the set of column combinations composed of two columns (0). Then, the worker consults the (non-)uniques graph to check whether it pruned the current column combination before, i.e., if it is a superset (or a sub-set) of an already found unique (non-unique) (1). If so, the worker then starts again from (0). Otherwise, the worker proceeds with the uniqueness check for the current column combination. For this, the worker reads the PLIs of all columns of the current column combination (2). Indeed, the worker might reuse existing PLIs of column combinations relevant to the current column combination.

For instance, assume the Ducc worker has to perform the uniqueness check for the column combination ABC. If the Ducc worker had previously computed the PLI for AB, then it would intersect the PLI of AB with the PLI of C. After the uniqueness check, the worker updates the (non-)uniques graph (3). Furthermore, if the current column combination is non-unique, the worker then adds the resulting PLI to the repository (4). This repository is a main memory data structure having a least-recently-used (LRU) replacement strategy. Then, the Ducc worker fetches the next column combination to check (5) and starts again from point (1). In case that the worker does not find any unchecked column combination in the current path, it restarts from point (0). The worker repeats this process until it does not find any more unchecked column combinations and seeds.

In the remainder of this section, we explain the Ducc worker in more detail (Section 3.2), then the strategies used by Ducc to efficiently traverse the lattice of column combinations (Section 3.3), and the set of lightweight data structures used by Ducc to perform fast uniqueness checks (Section 3.4).

3.2 DUCC Worker

Algorithm 1 shown in FIG. 4 details the way the Ducc worker operates to find all uniques and non-uniques in a given dataset. Notice that the approach followed by the Ducc worker is suitable for any bottom-up and top-down lattice-traversal strategy. The algorithm first checks each column individually for uniqueness by any suitable technique (Line 1), e.g., distinctness check in a DBMS. The worker adds all found unique columns to the set mUc (Line 2). At the same time, the worker enumerates all pairs of non-unique columns as seeds, i.e. as starting points for the graph traversal (Line 3).

In the main part of the algorithm (Lines 6-14), the worker processes all seeds that are given as starting points. For this, the worker first chooses a column combination K from the seeds to check for uniqueness (Line 7). Notice that one can provide any strategyTake function to decide how the worker chooses K. The advantage of providing this function is that one can control the parallelization of the Ducc process (see Section 5 for details). If K is unique and the worker already classified all subsets as non-unique, the worker then adds K to mUc (Line 10). Analogously, if K is non-unique and the worker already classified all supersets as unique, the worker then adds K to mnUc (Line 12).

Next, the worker invokes the strategyStep function to decide on the next column combination to check for uniqueness. Notice that by providing their own strategyStep, users can control the way the worker driver has to traverse the graph. If there are no more column combinations to check in the current path (i.e., supersets of the current seed), the strategyStep function then returns null (Line 14). In this case, the worker proceeds with the next seed (Line 6). The worker repeats this main process until there are no more seeds. However, the worker might not cover the complete lattice, because one might provide highly aggressive pruning strategies in the strategyStep function. Therefore, the worker may calculate a new set of seeds and reiterate the main process (Line 15).

To better understand the above process, let us show how one could implement an exhaustive bottom-up apriori algorithm in Ducc. The basic idea of an apriori-based algorithm is to generate combinations of a given size x (e.g., of size 4) by combining two column combinations of size x−1 (i.e., of size 3) that share x−2 columns. For example, ABC and ABD could generate ABCD. Overall, in Ducc, an apriori algorithm would iterate the above mentioned main process n−1 times, where n is the number of columns. At the beginning of each iteration i, the apriori algorithm would provide those column combinations of size sizei₊₁ as a set of seeds. The apriori algorithm would generate such column combinations using the non-unique combinations of size, that share a common set of columns. For example, at the very first iteration, the set of seeds is composed only of column combinations having two different non-unique columns. Then, the apriori algorithm would use a strategyTake function that removes and returns the first seed element and a strategyStep function that always returns null. Consequently, the apriori algorithm would check each column combination in the set of seeds for uniqueness. Once the apriori algorithm finishes checking all seeds, it would start a new iteration i by recalculating the next set of seeds. To this end, the apriori algorithm would use a strategyNextSeeds function that forms all column combinations of size sizei₊₁. The particularity of an apriori algorithm is that each detected unique is a minimal unique, because the algorithm prunes all supersets for future iterations. The apriori algorithm would continue this process until no new seeds can be formed by the strategyNextSeeds function.

3.3 Graph Traversal Strategies

It is worth noting that the strategyTake and strategyStep functions play an important role in the performance of Ducc, because they guide the Ducc worker in how to explore the lattice (see Section 3.2). In this section, we provide two advanced graph traversal strategies (Greedy and Random Walk) that allow Ducc to traverse the lattice efficiently. These strategies allow Ducc to cover the lattice by visiting only a very small number of column combinations. Generally speaking, the main goal of the Greedy strategy is to find minimal uniques as fast as possible in order to prune all supersets from the search space. As a side effect, this strategy also prunes all subsets of non-uniques that are discovered in the process. However, a limitation of the Greedy strategy is that it is not well suited for parallel computation, because all computation units can quickly converge to the same combinations causing much redundant computation. One might think of frequently sharing local decisions among Ducc workers to deal with this issue, but this would require significant coordination among Ducc workers. This is why we introduce the Random Walk strategy, which achieves an efficient parallelization. Indeed, as the Greedy and Random Walk strategies are two aggressive pruning techniques, they might miss some column combinations in the lattice. In Section 4, we discuss how Ducc finds such missing column combinations to always provide a complete solution set. We now discuss in detail the two advanced graph traversal strategies.

Greedy. The main idea of the Greedy strategy is to first visit those column combinations that are more likely to be unique. For this, Greedy maintains a priority queue to store distinctness estimates for potentially unique column combinations. The distinctness d:S→(0; 1] is the ratio of the number of distinct values over the number of all values. A distinctness d(K)=1 means that column combination K is unique; the distinctness of a column combination with many duplicates approaches 0. A sophisticated estimation function may allow Ducc to better prune the search space, but it can be too costly to perform, outweighing any accuracy gain. Thus, we favor a simple estimation function d~ inspired by the addition-law of probability:

d~(P₁P₂)=d(P₁)+d(P₂)−d(P₁)*d(P₂) (1)

Using the above estimation function, we use a greedyTake function (which is an implementation of strategyTake) that chooses the seed with the highest estimate. Similarly, we use a greedyStep function (which is an implementation of strategyStep) as shown in Algorithm 2 in FIG. 5. For each given non-unique column combination, greedyStep removes all subsets of the given column combination from the priority queue (Line 2), calculates the estimates for every unchecked superset (Line 3), and updates the priority queue (Line 4). In turn, for each given unique column combination, greedyStep simply removes all supersets of the given column combination from the priority queue (Line 6). At the end, greedyStep returns the elements with the highest estimated distinctness (Line 7). This means that Greedy returns either a superset or subset of the given column combination. It is worth noticing that greedyStep might render some column combinations unreachable, because it prunes simultaneously from the top (Line 2) and the bottom (Line 6). Therefore, Ducc has to identify such possible “holes” in the lattice and consider them in a next iteration (Line 15 of Algorithm 1). In Section 4, we describe an approach (for the strategyNextSeeds function) to efficiently identify those holes.

Random Walk.

This strategy traverses the lattice in a randomized manner to reduce both unnecessary computation and the coordination among workers. Random Walk strategy starts walking from a seed upwards in the lattice until it finds a unique and then it goes downwards in the lattice until it finds a non-unique. When Random Walk finds a non-unique, it again walks upwards looking for a unique and so on. The main idea behind Random Walk is to quickly converge to the “border” in the lattice that separates the uniques from the non-uniques and walk along such a border. All minimal uniques and maximal non-uniques lie on this border. In contrast to Greedy, Random Walk reduces the likelihood of converging to the same column combinations when running in parallel.

Random Walk implements a randomWalkTake function (i.e., strategyTake) that chooses a seed randomly. Additionally, Random Walk maintains a walk trace, which is initialized with the seed. For walking through the lattice, this strategy implements a randomWalkStep function (i.e., strategyStep) that works as shown in Algorithm 3 in FIG. 6. First, Random Walk pushes the current column combination into the walk trace. Next, it verifies whether the current column combination is unique. If it is, Random Walk then goes up to a random, yet unchecked superset (Line 3). If not, it analogously chooses a random subset (Line 5). If Random Walk cannot make any additional step from the current combination, it then backs up one step and uses the previous combination (Line 7). The strategy repeats this process until it completely explored the reachable lattice from the given seed. It is worth noticing that Lines 3 and 4 not only check for (non-)uniqueness, but also check whether the current column combination is covered by a known unique or non-unique. This allows Random Walk to lazily prune the search space from the bottom and the top similar to Greedy. As a result, Random Walk might make some column combinations unreachable in the lattice. Thus, Random Walk applies the same approach to detect and explore holes in the lattice (see Section 4).

3.4 Light-Weight Data Structures

At its core, Ducc uses a set of data structures that allows it to quickly check if a given column combination is either unique or non-unique. The three most important data structures used by Ducc are: a position list index, a (non-)uniques graph, and a path trace. Generally speaking, Ducc uses: (i) the position list index to efficiently perform a uniqueness check, (ii) the (non-)unique graph to avoid uniqueness checks of already pruned column combinations, and (iii) the path trace to quickly obtain the next column combination (in the current path) to check. We discuss each of these data structures below.

Position List Index.

The position list index (PLI) is a data structure that keeps track of duplicate tuples for a specific column (or column combination). In other words, each entry in the PLI of a given column is a set of tuple-ids having the same value for the given column. For example, given an attribute a with two sets of duplicates (records r₄₂ and r₁₀ for the value v₁ and records r₇ and r₂₃ for the value v₂), the PLI of a is as follows: PLIₐ={r₄₂, r₁₀}, {r₇, r₂₃}. Since PLIs track only duplicates in a column (or column combination), Ducc maintains one PLI for each non-unique column (and column combination) in a relation. Therefore, columns or column combinations without a PLI are uniques. Notice that Ducc computes the PLI of a column combination by intersecting the PLIs of its subsets. As a result of using PLIs, Ducc can also apply row-based pruning, because the total number of positions decreases monotonously with the size of column combinations. Intuitively, combining columns makes the contained combination values more specific with the tendency towards distinctness. This means that each intersection of PLIs results in smaller or equal-size PLIs for the values of the considered column combinations. We observed that the size of such PLIs follow a power law distribution, where the size of most PLIs are in the order of KBs for TBs-sized datasets. It is worth noticing that Ducc intersects two PLIs in linear time in the size of the PLIs. This allows Ducc to perform an intersection in a few milliseconds. In fact, Ducc intersects two PLIs in a similar way in which a hash join operator would join two relations.

FIG. 7 shows an example of intersecting two PLIs (A and B). The PLIs A and B are composed of two different sets of duplicate records each: A₁ and A₂ for A and B₁ and B₂ for 8. In this scenario, Ducc first builds a mapping between each duplicate record rᵢ to the set of duplicates they point to (1), e.g. r₁ points to set A₁. Ducc uses this mapping to probe each duplicate record in B (2). This results in a set of duplicate records that appear in both PLIs. For example, records r₁ and r₃ appear in the resulting sets A₁ and B₁, record r₂ appears in the resulting sets A₁ and B₂, and record r₅ appears in the resulting sets A₂ and B₂. Notice that record r₄ does not appear in any resulting set, because it appears in only one set (set A₂). Finally, Ducc keeps those resulting sets with more than one record (3). In this example, Ducc retains the set with the records r₁ and r₃.

(Non-)Uniques Graph.

The (non-)unique graph is a data structure that maintains, for each column, a list of non-redundant uniques and non-uniques containing the column. This data structure allows Ducc to use a lazy pruning strategy rather than using an eager pruning strategy. In particular, Ducc uses the (non-)uniques graph to check if any given column combination is a superset (or subset) of an already found unique (non-unique) column combination. The main goal of performing this check for a given column combination is to save CPU cycles by avoiding intersecting the PLIs of the columns in the given column combination as well as ending the search path as early as possible. The challenge is that we have to check whether a superset or subset of any given column combination exists in the order of few milliseconds. Otherwise, this checking becomes more expensive than the PLIs intersection itself. For each column, Ducc indexes all non-redundant (non-)uniques in which the column is involved in order to achieve fast lookups of the (non-)uniques graph. Indeed, the index size of a column might become too large, which, in turn, increases lookup times. Therefore, we use a main memory-based, dynamic hash-based index structure. The idea is that whenever the index of a given column becomes too big, we split the index into smaller indexes of column combinations having such a column. For example, assume a relation with four attributes: A, B, C, and D. If the index for column A (or for column combination BD) goes beyond a given threshold, we split such an index into the indices AB, AC, and AD (respectively, into indexes ABD, BCD). This allows us to guarantee on average fast lookups on the (non-)uniques graph.

Path Trace.

Since Ducc can traverse the lattice by going up and down, Ducc uses this data structure to efficiently find another path to explore when it finishes checking all column combinations of a single path. The way Ducc implements this data structure depends on the graph traversal strategy it uses. Random Walk keeps track of previously visited column combinations in a stack-like trace. In contrast, Greedy maintains a Fibonacci heap that ranks column combinations by their estimated distinctness.

### 4. PLUGGING HOLES

Since Ducc makes use of aggressive pruning techniques, it might miss some column combinations. In other words, Ducc might make some column combinations unreachable, i.e., there is no longer a “walk” in the lattice to those column combinations. Therefore, in this section, we present a fast technique to identify these “holes” in the lattice and prove that Ducc always finds the complete solution. We first make some important observations in Section 4.1. We then present our approach to identify possible holes in the lattice (Section 4.2) and to remove holes from the lattice (Section 4.3).

4.1 Observations

Let us first highlight that for any given unique column combination there exists a minimal unique column combination that is a subset of or equal to the given column combination. Formally,
Lemma 1. KεUc [symbol] ∃K′εmUcs: K′⊂K

Proof (Sketch). Either K is already minimal, or we can iteratively remove columns as long as K remains unique. By Definition 2, the result after this removal process is a minimal unique. The negation of the equivalence means that if we cannot find such a minimal combination, then K is non-unique

We remark that it suffices to know all minimal unique column combinations to classify any other column combination as either unique or non-unique. We state this in Lemma 2.
Lemma 2. Given only the set mUcs of all minimal uniques and given any column combination K, we can determine whether K is unique or non-unique.
Proof. We know from Lemma 1 that K is unique iff ∃K′ε

mUcs: K′⊂K. Otherwise, we know that K is non-unique by applying the negation of Lemma 1: KεnUc [symbol] [symbol] K′εmUcs: K′⊂K.

It is worth noticing that Lemmata 1 and 2 are analogously true given the set mnUcs of all maximal non-uniques. Therefore, taken together, either the set mUcs or the set mnUcs is sufficient to classify each node of the lattice:
Corollary 1. Given the complete set of mnUcs for a given relation, one can construct the complete set mUcs for that relation and vice-versa. We call the constructed set the complementary set mnUcs^{C}=mUcs.

Notice that the two sets mUcs and mnUcs do not need to have the same cardinality.

4.2 Finding Holes

We leverage the observations we made in the previous section to identify possible holes in the lattice and to verify that our result is complete. The basic idea is to compare the set mnUc with the set mUc^{C}. If there is a difference, we can then conclude (from Corollary 1) that there are holes in the lattice. In fact, the difference of such sets effectively describes at least one column combination in each existing hole. Thus, we use such a difference to find holes in the lattice. Ducc takes this difference as seeds for new iterations of the (non-)unique discovery process. Ducc stops iterating this process until the difference of mnUc with mUc^{C} is empty.

Intuitively, we can verify whether Ducc produces the complete and correct results using the analogy of marking or coloring the lattice nodes according to their uniqueness. It is worth noticing that we assume we have no incorrect column combination in Ucs or nUcs: the sets may merely be incomplete.

Assume we miss one KεmnUcs. We start marking or coloring the nodes of the lattice twice according to Corollary 1. In other words, we color all non-uniques in nUcs and all uniques in the derived nUcs^{C}. Since we assumed that K<mnUcs, we must color K as unique, because by definition of mnUc there cannot be any other maximal non-unique that covers K. We, then, color the lattice according to Ucs and Ucs^{C}. Here, we must color K as non-unique, because we cannot possibly find any evidence that K is unique. We can resolve this contradiction only by assuming that Ucs and nUcs describe different lattices and thus they are not complete. Formally, we show how to check whether Ducc produces the complete and correct results in Theorem 1.
Theorem 1. Given a lattice with its corresponding sets mUcs and mnUcs and (intermediate) solution sets U⊂mUcs and N⊂mnUcs, then (U=mUcs ̂N=mnUcs) [symbol] N^{C}=U
Proof. “ [symbol] ”: follows directly from Corollary 1. “ [symbol] ”: we show this direction (i.e., right to left) for U only; the case for N is analogous. In particular, we show the inverse, i.e., if U⊂mUcs then U^{C}, N: If U⊂mUcs there is at least one K εmUcs\U. We can now show that ∃K′⊃K with K′εU^{C} and K′<N, thus showing U^{C}, N. K′εU^{C} is true: As K<U it is non-unique (according to U and Lemma 2). Thus, with Lemma 1, we can find one corresponding maximal non-unique K′εU^{C}. K′<N is also true:

Because KεmUcs, any superset K′εUcs, but N∩Ucs=Ø.

4.3 Removing Holes

Having shown how to identify holes in the lattice, we now show that Ducc eventually converges to the complete solution.
Corollary 2. Given a lattice with its corresponding sets mUcs and mnUcs and intermediate solution sets U⊂mUcs and N mnUcs then for any KεN^{C}\U:
(∃K′εmUcs\U:K′⊂K) [symbol] (∃K′εmnUcs\N:K′⊃K)

Each KεN^{C}\U describes a column combination that should be a minimal unique according to N, but is not contained in U. Thus, this element is either a minimal unique and is added to U or it is a non-unique. In the latter case, it must lead to a new maximal non-unique according to Lemma 1, because it was not covered so far. In both cases, we append to U or N and hence eventually converge to the complete solution. The same holds if N≠mnUcs.

### 5. SCALING DUCC UP AND OUT

So far, we assumed that Ducc runs on a single computing node and without multi-threading. While that setup might be enough for some applications, when dealing with big data one should use several CPU cores and multiple computing nodes. We now relax the assumption and discuss how Ducc can scale to several CPU cores as well as to several computing nodes. In this section, we present a general inter-process communication protocol to scale Ducc up and out at the same time with a low synchronisation overhead. We discuss these two points in the remainder of this section.

5.1 Scale Up

As Ducc is mainly CPU-bound, one might think that by scaling the CPU up (in terms of speed and number of cores) Ducc can achieve linear scalability by running in a multi-threading manner. However, multi-threading comes at a price: it usually incurs a high overhead due to data structure locking and threads coordination. To overcome this issue, Ducc mainly relies on a lock-free coordination mechanism, which allows Ducc to have almost no overhead when scaling up to several threads.

Lock-Free Worker Coordination.

Running on multiple workers requires Ducc to propagate the observations done by each worker to others workers in order to avoid redundant computations across workers. A simple way of doing this would be by sharing the (non-)uniques graph among all Ducc workers. Ducc would require a locking mechanism to coordinate all write operations to these graphs. However, it has been shown by other researchers that locking mechanisms usually incur high overheads. Therefore, Ducc uses a lock-free coordination mechanism to propagate observations among workers. This mechanism mainly relies on two features. First, each Ducc worker maintains a local copy of all uniques and non-uniques column combinations already observed by other workers (internal (non)uniquesgraph, for short). Second, Ducc workers share a local event bus to efficiently propagate observations across workers. Thus, the synchronization between threads is reduced to concurrent access on the event bus. FIG. 8 illustrates the distributed architecture of Ducc.

Producer-Consumer Pattern.

This local event bus operates in a producer-consumer manner to avoid that a Ducc worker waits for observations made by other Ducc workers. Each Ducc worker subscribes and exposes an event queue to the local event bus. When a Ducc worker finishes with the uniqueness check of a given column combination, it updates its internal (non-)uniques graph with the resulting observation, and pushes such an observation to the local event bus ((1) in FIG. 8). In turn, the local event bus enqueues every incoming observation into the event queue of each subscribed Ducc worker. Then, a Ducc worker updates its internal (non-)uniques graph with the observations that are in its own event queue, i.e., with the observations made so far by other workers. Ducc workers pull observations from their queues right after pushing their own observations to the local event bus. The main advantage of this mechanism is that it allows a Ducc worker to update its internal (non-)uniques graph as well as to push and pull the resulting observations in the order of microseconds.

Asynchronous Seed Provider.

A limitation in scaling up is the discovery of holes. Near the end of one iteration of Ducc (i.e., when all workers eventually run out of seeds), workers redundantly perform the same calculation to find new seeds. Therefore, we extracted the seed calculation process into a separate thread “seed provider”. The seed provider continuously tries to detect new holes when new minimal uniques or maximal non-uniques have been found and propagated over the local event bus. The order in which Ducc chooses each seed depends on the strategy used by Ducc to traverse the graph (in particular on the strategyTake function).

5.2 Scale Out

Indeed, only scaling Ducc up does not help us to deal with big datasets in an efficient manner. This is mainly because big datasets are typically in the order of terabytes or petabytes: bringing one petabyte of raw data into main memory using a single computing node with one hard disk (having a sustained rate of 210 MB/s) would take 59 days. Therefore, it is crucial for Ducc to scale out to many computing nodes to efficiently deal with big datasets. To achieve this, Ducc uses the Hadoop MapReduce framework to parallelize the unique discovery process across several computing nodes. Ducc runs a map-only MapReduce job where each map task takes a seed at random and traverse the graph starting from the chosen seed as explained in Section 3. To prune the search space, each map task maintain a PLI, a (Non-)Uniques Graph, and a Path Trace data structure locally, as explained in Section 3.4. However, maintaining these three light-weight data structures only locally would make each map task perform redundant work: map tasks would not share their observations with each other. Thus, it is crucial each map task share its observations with other map tasks. This implies to propagate hundreds of thousands (or even millions) of observations through the network. Indeed, propagating such a large number of messages through the network would also negatively impact the performance of Ducc.

To deal with this problem, Ducc uses a selective inter-node communication, which allows Ducc to make a tradeoff between network traffic and redundant work. The idea is to propagate only the observations concerning minimal uniques and maximal non-uniques across nodes ((4) in FIG. 8). The intuition behind this is that minimal uniques and maximal non-uniques by definition prune more combinations than non-minimal/maximal combinations and we have thus a good ratio between communication overhead and pruning effect. Additionally, each worker needs less time to maintain its (non-)unique graph, which becomes increasingly important when scaling out to multiple of computing nodes. Ducc leverages Kafka (kafka.apache.org) as distributed event bus to efficiently propagate local observations to all Ducc workers. Similar to the local event bus (see Section 5.1), the distributed event bus follows the same producer-consumer pattern. The local event bus subscribes and exposes an event queue to the distribute event bus, which in turn enqueues every incoming observation into the queue of each subscriber. Nonetheless, in contrast to the local event bus, the distributed event bus propagates observations regarding only minimal uniques and maximal non-uniques to avoid congesting the network.

### 6. EXPERIMENTS

We evaluate the efficiency of Ducc to find minimal unique column combinations and maximal non-unique column combinations. We compare Ducc with two state-of-the-art approaches: Gordian and HCA. We perform the experiments with three main objectives in mind: (i) to evaluate how well Ducc performs with different numbers of columns and rows in comparison to related work; (ii) to measure the performance of Ducc when scaling up to several CPU cores; (iii) to study how well Ducc scales out to several computing nodes.

6.1 Setup

Server.

For all our single node experiments, we use the following server: two 2.67 GHz Quad Core Xeon processors; 32 GB of main memory; 320 GB SATA hard disk; Linux CentOS 5.8 64-bit version. Each computing node has a 64-bit Java 7.0 version installed.

Cluster.

For our scale-out experiments, we use a cluster of nine computing nodes where each node has: Xeon E5-2620 2 GHz with 6 cores; 24 GB of main memory; 2×1 TB SATA hard disk; one Gigabit network card; Linux Ubuntu 12.04 64-bit version. Each computing node has a 64-bit Java 7.0 version installed. One node acts as Hadoop, Kafka, and ZooKeeper master and the other eight nodes as slaves.

Datasets.

We use two real-world datasets and one synthetic dataset in our experiments. The North Carolina Voter Registration Statistics (NCVoter) dataset contains non-confidential data about 7,503,575 voters from the state of North Carolina. This dataset is composed of 94 columns and has a total size of 4.1 GB. The Universal Protein Resource (UniProt, www.uniprot.org) dataset is a public database of protein sequences and functions. UniProt contains 539,165 fully manually annotated curated records and 223 columns, and has a total size of 1 GB. Additionally, we use the synthetic lineitem table with scale-factor 1 from the TPC-H Benchmark. The lineitem table has 16 columns. For all datasets the number of unique values per column approximately follows a Zipfian distribution: few columns have very many unique values and most columns have very few unique values.

Systems.

We use the state-of-the-art Gordian and HCA techniques as baselines. While Gordian is a row-based unique discovery technique, HCA is an improved version of a bottom-up apriori technique. We use a best-effort java implementation of Gordian according. For HCA, we use the same prototype, but, for fairness reasons, we store the input dataset in main memory rather than in a disk-based database. For the scale-out experiments, we use Hadoop v0.20.205 with the default settings. For all our experiments, we execute these three systems three times and report the average execution times. Finally, it is worth noting that we do not show the results for Ducc using the Greedy strategy, because the results are very similar to the results obtained by Ducc when using the Random Walk strategy.

6.2 Scaling the Number of Columns

In these experiments, we vary the number of columns to evaluate how well

Ducc performs with respect to wide tables. We limit the number of rows to 100 k to better evaluate the impact in performance of having a different number of columns.

FIG. 9a illustrates the results for NCVoter. For few columns, such as 5 and 10, all algorithms finish in seconds. However, in both cases Gordian performs worst by needing each time more than 20 seconds while Ducc and HCA both finish within 2 seconds for 5 columns. On the dataset with 10 columns. within 3 seconds runtime DUCC is already faster than HCA, which needs more than 8 seconds. From 15 columns, Gordian starts to outperform HCA by nearly one order of magnitude. As the number of columns increases the bottom-up approach HCA runs into problems. The runtime of Ducc stays below 4 seconds, outperforming HCA by 2 orders of magnitude and Gordian by one order of magnitude. On the dataset with 20 columns, HCA is already by more than 2 orders of magnitudes slower than Gordian and is not able to finish on the dataset with 25 columns within 10 hours. Comparing to HCA, the runtime of Gordian increases moderately until 55 columns when Gordian is also not able to finish in 10 hours. On 50 columns Ducc is still one order of magnitude faster than Gordian and is also able to process the NCVoter dataset with up to 65 columns within 10 hours (it finishes in 5.7 hours).

FIG. 9b shows the results for the UniProt dataset. In these results, we observe a similar behaviour of all three systems as in the results for the NCVoter dataset. As this dataset has fewer and smaller uniques, all algorithms perform better than on the NCVoter dataset. In the experiments with 5 and 10 columns, Ducc is slightly slower than HCA since the only existent uniques are single columns, which benefit HCA. Still, Ducc is one order of magnitude faster than Gordian, which mainly suffers from the overhead of creating the prefix tree. From 15 columns on, we observe that the runtime behavior is similar to the experiments on the NCVoter dataset. Ducc significantly outperforms HCA and increases its improvement factor over Gordian as more and larger uniques can be found in the lattice. For example, Ducc is already two orders of magnitude faster than HCA for 15 columns: Ducc runs in 4.7 seconds while HCA runs in 485 seconds. This difference in performance increases significantly on 20 columns, where Ducc runs in 5.7 seconds and HCA runs in 2,523 seconds. Again, we aborted HCA after 10 hours for the experiment with 25 columns. Ducc outperforms Gordian already from 25 columns on by more than one order of magnitude. When running over 50 columns, Ducc is almost three orders of magnitude faster than Gordian. We also observe that Ducc is the only one finishing the experiment on 70 columns in nearly three hours. However, for 75 columns, we also aborted Ducc after 10 hours.

FIG. 9c illustrates the results for the lineitem table from the TPC-H benchmark. These results show again that, for few columns (5 columns), Ducc has the same performance as HCA and more than one order of magnitude better performance than Gordian. Ducc and HCA finished both in 2 seconds while Gordian needed 30 seconds. Ducc significantly outperforms both Gordian and HCA on more than 5 attributes. In general, as lineitem contains only 16 columns, all algorithms could deal with the column dimension of this dataset. However Ducc was one order of magnitude faster than HCA running on 10 columns and two orders of magnitude on 15 and 16 columns. Throughout all column configurations, Ducc was one order of magnitude faster than Gordian.

In summary, we can make the following observations. On the one hand, we observe that HCA has low performance on datasets with many columns: HCA must verify all column combinations on the lower levels of the lattice in order to discover minimal uniques of large size. In contrast, Ducc keeps visiting relevant nodes around the minimal uniques and maximal non-uniques border only. For example, on the UniProt dataset with 20 columns and 92 minimal uniques in a solution space of 2²⁰−1=1,048,575 combinations, Ducc performs only 756 uniqueness checks resulting into 1,156 intersections while HCA has to perform 31,443 verifications. On other hand, Gordian runs into performance bottlenecks at two stages. First, Gordian mainly operates on a prefix tree, which is expensive to create in many cases. Second, Gordian requires considerable amount of time to generate minimal uniques from maximal non-uniques when input datasets have a high number of minimal uniques. Finally, we observe that, in contrast to Gordian and HCA, Ducc mainly depends on the number of minimal uniques and not on the number attributes.

6.3 Scaling the Number of Rows

We now evaluate Ducc under a different number of rows and compare it to both Gordian and HCA. For this, we fixed the number of columns of each dataset at 15, because Gordian and HCA significantly decrease their performance for more columns. Then, we scale each dataset (starting from 10,000 rows) by a factor of 10 until we reached the total size of the dataset.

FIG. 10 shows the results for these experiments. We observe in FIG. 10a that only Ducc was able to finish the total dataset within the 10 hour time frame: it finishes in 294 seconds. We had to abort both Gordian and HCA after ten hours. We observe that Ducc outperforms both Gordian and HCA in general. In particular, we observe that the improvement factor of Ducc over both Gordian and HCA increases as the number of rows increases. For example, Ducc outperforms HCA by an improvement factor of 5 (and Gordian by an improvement factor of 1.25) for 10 k rows and by an improvement factor of 185 (of 225 for Gordian) for 1 million rows. FIG. 10b illustrates the results for UniProt, which is much smaller than NCVoter. We observe that Ducc outperforms both Gordian and HCA from 100,000 rows by more than one order of magnitude. Especially, Ducc outperforms both systems by two orders of magnitude on the complete dataset.

FIG. 10c shows the results for TPC-H. Here, we observe the same behavior as for NCVoter and UniProt. Ducc outperforms Gordian and HCA by more than two orders of magnitude. In fact, Ducc is the only one that was able to finish line item with a scale factor of 1 (which contains more than 6 million rows).

In general, we see that Ducc is clearly superior than both baseline systems in all our experiments. Especially, we observed that this is due to the fact that Ducc mainly depends on the number of minimal uniques and not on the number of columns. We study this aspect in detail in the next subsection. We could also observe that in FIGS. 10a and 10b, Ducc could not finish within 10 hours. Therefore, we later evaluate how well Ducc can scale up and out in Sections 6.5 and 6.6. In the following experiments, we use only Ducc since both Gordian and HCA are single-node approaches

6.4 Number of Uniqueness Checks

In the previous two subsections, we observed that Ducc performs increasingly better on larger numbers of columns and rows than the previous approaches. The reason is that, in contrast to state-of-the-art algorithms, Ducc mainly depends on the solution set size and not on the number of columns. As a result, Ducc conducts a much smaller number of uniqueness checks.

FIG. 11 illustrates the correlation between the number of uniqueness checks performed by Ducc and the number of minimal uniques for NCVoter with 5 to 70 columns. In this FIG. 11, the line denotes the regression line and the data points are the real number of uniqueness checks performed by Ducc to find all minimal uniques. Note that for the points for up to 35 columns are near to (0, 0). We observe a strong correlation (coefficient of determination R²=0.9983) between the number of checks performed by Ducc and the number of minimal uniques. This clearly shows that Ducc approaches the border between uniques and non-uniques very efficiently. For example for 70 columns, Ducc performs 476,881 intersections to find the 125,144 minimal uniques. This number of checks is roughly double as high as the lower bound to find all minimal uniques. The lower bound, in turn, is given by the number of minimal uniques plus the distinct number of their subsets to verify minimality. It is worth noting that Ducc performs more checks than the lower bound, because it has to check some additional column combinations that are also candidates for being in mUc or mnUc.

6.5 Scale-Up

We now evaluate how well Ducc exploits multiple CPU cores to improve execution times. For this, we use the entire NCVoter dataset since this is the biggest dataset and Ducc showed its limitations with this dataset (see FIGS. 13a and 13b).

FIG. 12 shows the scale up results for Ducc. As expected, we see that using more workers speed up Ducc significantly with increasing number of columns. In particular, we observe that four working threads perform more than twice faster than one thread for 20 or more columns. Adding the hyperthreaded cores does not speed up the task any further. The suboptimal speedup is caused by overlapping paths of the random walk algorithm. Although redundant intersections can be avoided with our (non-)unique graphs, Ducc still needs to find unseen paths for each thread. This becomes increasingly difficult with later iterations. Especially, plugging holes becomes a bottleneck for parallelization, because the seed provider takes longer to detect the holes than the worker threads need to plug them. It is worth noticing that, at the end, many of the working threads idle or perform redundant checks in parallel.

In summary, adding more working threads speeds up Ducc significantly, especially in the beginning. However, scaling up does not help to process datasets that do not fit into main memory.

6.6 Scale-Out

In Sections 6.3 and 6.2, we have considered a single node in all our experiments for fairness reasons with respect to baseline systems. We now release this assumption and run Ducc on up to eight nodes to measure the impact of scaling out. At the same time, we also scale-up on each individual node.

FIG. 13 shows the results when using 1, 2, 4, and 8 computing nodes (each node with 1 and 4 threads). We see a similar speed-up when scaling out in comparison to scaling up. Interestingly, there is not a significant difference in running 4 workers on 1 machine or 4 machines with 1 worker. Thus, depending on the infrastructure at hand, users may decide to speed up the process by using a few big machines or several small machines. For example, for 45 columns, increasing the nodes with one thread from two to eight decreases the runtime by factor 3. Increasing the number of threads to four further halves the runtime. Finally, we also observed in our experiments that the overhead of scaling out with Hadoop is negligible: 1.5 minutes on average. These results show the high efficiency of Ducc to scale out at a very low overhead.

### 7. NULL-VALUE SEMANTICS

In our discussion and problem definition we have yet ignored the presence of null-values (⊥) in the data. We have thus implicitly assumed a SQL-semantic in which (⊥=⊥) evaluates to unknown and thus two null-values do not constitute a duplication of values.

Discovered uniques conform to SQL's UNIQUE constraint, which allows only unique non-⊥-values and multiple ⊥-values. In an extreme case, a column with only nulls forms a minimal unique. Table 1 shown in FIG. 14 shows example relations for different null-value semantics.

An alternative semantics is to let (⊥=⊥) evaluate to true: in effect ⊥-values are not distinct and multiple ⊥-values render a column non-unique. To illustrate the difference for our problem, regard the small relation of Table 1. Under SQL semantics we can identify both A and C as minimal uniques and BD as maximal non-unique. Maybe surprisingly and for a data analyst unintuitive, the uniqueness of C implies that also CD is unique. This interpretation changes under the alternative semantics. There, A and BC are minimal uniques, and BD and CD are maximal non-uniques. Both semantics are of interest in a data profiling context.

The implementation of this alternative requires only a small change in the Ducc algorithm: When creating the initial PLIs, we retain a group of all ⊥-values and thus mark them as duplicates. In this way, we save significant time, because the solution set contains orders of magnitudes fewer minimal uniques. Hence, Ducc can process the complete lattice more quickly.

FIG. 15 shows an experiment in which we were able to detect all 841 minimal uniques in the complete UniProt dataset with 223 columns in only 4 hours. Notice that this is infeasible with state-of-the-art algorithms even with this alternative semantics of null-values. Furthermore, the alternative semantic has the additional benefit that both the number as well as the size of the minimal uniques are more manageable: The largest minimal unique had nine columns and the median minimal unique seven. With the SQL semantics, minimal uniques can easily consist of half the columns.

### 8. RELATED WORK

Even if the topic of discovering unique column combinations is of fundamental relevance in many fields (such as databases and bioinformatics), there have been only few techniques to solve this problem. Basically, there exist only two different classes of techniques in the literature: column-based and row-based techniques.

Row-based techniques benefit from the intuition that non-uniques can be detected without considering all rows in a table. Gordian is an example of row-based techniques. Gordian pre-organizes the data of a table in form of a prefix tree and discovers maximal non-uniques by traversing the prefix tree. Then, Gordian computes minimal uniques from maximal non-uniques. The main drawback of Gordian is that it requires the prefix tree to be in main memory. However, this is not always possible, because the pre-fix tree can be as large as the input table. Furthermore, generating minimal uniques from maximal non-uniques can be a serious bottleneck when the number of maximal non-uniques is large.

Column-based techniques, in turn, generate all relevant column combinations of a certain size and verify those at once. Giannella et al. proposed a column-based technique for unique discovery that can run bottom-up, top-down, and hybrid with regard to the power-set lattice of a relation's attributes. Their proposed technique is based on the apriori intuition that supersets of already discovered uniques and subsets of discovered non-uniques can be pruned from further analysis. However, this approach does not scale in the number of columns, as realistic datasets can contain uniques of very different size among the powerset lattice of column combinations. Furthermore, their verification step is costly as it does not use any row-based optimization.

HCA is an improved version of the bottom-up apriori technique. HCA performs an optimised candidate generation strategy, applies statistical pruning using value histograms, and considers functional dependencies (FDs) that have been inferred on the fly. If the maximal non-unique discovery part of Gordian is combined with HCA, there are some performance improvements on datasets with large numbers of uniques. However, since HCA is based on histograms and value-counting, there is no optimization with regard to early identification of non-uniques in a row-based manner.

Ducc combines the benefits of row-based and apriori-wise column-based techniques, which allows it to perform by orders of magnitude faster than the above mentioned existing work (see Section 6 for details).

### 9. CONCLUSION

Embodiments of the invention seek to address the problem of finding all unique and non-unique column combinations in big datasets (e.g, in datasets having billion rows and hundreds attributes). The unique discovery problem is challenging given the exponential number of column combinations to check. In fact, it has been shown to be an NP-hard problem. Existing works propose efficient techniques, but none are designed with big datasets in mind. Therefore, all these techniques strongly depend on the number of columns and hence they suffer from scalability issues.

An embodiment of the invention incorporates Ducc, a highly scalable and efficient approach to find (non-)unique column combinations in big datasets. Ducc uses a novel hybrid graph traversal technique, which is a combination of the depth-first and random walk strategies. Ducc starts traversing the graph in a depth-first manner until it finds the first unique and then it starts following the boundary between uniques and non-uniques in a random walk manner. This allows Ducc to mainly depend on the solution set size rather than on the number of columns. Ducc also uses several light-weight structures that allow it to perform uniqueness checks in just a few milliseconds. As a result of its graph traversal technique and its light-weight data structures, Ducc can efficiently find uniques and non-uniques in big datasets. Additionally, Ducc runs on several CPU cores and computing nodes to achieve even a higher scalability.

Ducc has been evaluated using two real-world and one synthetic datasets and compared it with two state-of-the-art systems: Gordian and HCA. The results show the high superiority of Ducc over both; it outperforms Gordian by up to 2.8 orders of magnitude and HCA by up to 2.6 orders of magnitude. A series of scalability experiments showed the efficiency of Ducc to scale up to several CPU cores and to scale out to multiple computing nodes. Also, our experimental results showed that Ducc mainly depends on the solution set size and not on the number of columns. As a result, Ducc can achieve what before was not possible: processing datasets with hundreds of columns and several millions of records.

When used in this specification and the claims, the term “comprises” and “comprising” and variations thereof mean that specified features, steps or integers and included. The terms are not to be interpreted to exclude the presence of other features, steps or compounds.

### TECHNIQUES AVAILABLE FOR IMPLEMENTING ASPECTS OF EMBODIMENTS OF THE INVENTION

[1] Z. Abedjan and F. Naumann. Advancing the discovery of unique column combinations. In Proceedings of the International Conference on Information and Knowledge Management (CIKM), pages 1565-1570, 2011.
[2] R. Agrawal and R. Srikant. Fast algorithms for mining association rules in large databases. In Proceedings of the International Conference on Very Large Databases (VLDB), pages 487-499, 1994.
[3] J. Bauckmann, Z. Abedjan, U. Leser, H. Müller, and F. Naumann. Discovering conditional inclusion dependencies. In Proceedings of the International Conference on Information and Knowledge Management (CIKM), pages 2094-2098, 2012.
[4] J. Bauckmann, U. Leser, F. Naumann, and V. Tietz. Efficiently detecting inclusion dependencies. In Proceedings of the International Conference on Data Engineering (ICDE), pages 1448-1450, 2007.
[5] L. Bravo, W. Fan, and S. Ma. Extending dependencies with conditions. In Proceedings of the International Conference on Very Large Databases (VLDB), pages 243-254, 2007.
[6] P. G. Brown and P. J. Haas. BHUNT: Automatic discovery of fuzzy algebraic constraints in relational data. In Proceedings of the International Conference on Very Large Databases (VLDB), pages 668-679, 2003.
[7] G. Cormode, L. Golab, K. Flip, A. McGregor, D. Srivastava, and X. Zhang. Estimating the confidence of conditional functional dependencies. In Proceedings of the International Conference on Management of Data (SIGMOD), pages 469-482, 2009.
[8] W. Fan. Dependencies revisited for improving data quality. In Proceedings of the Symposium on Principles of Database Systems (PODS), pages 159-170, 2008.
[9] W. Fan, F. Geerts, J. Li, and M. Xiong. Discovering conditional functional dependencies. IEEE Transactions on Knowledge and Data Engineering (TKDE), 23(5):683-698, 2011.
[10] C. Giannella and C. Wyss. Finding minimal keys in a relation instance. http://citeseerx.ist.psu.edu/viewdoc/summary?doi=10.1.1.41.7086, 1999. Last accessed on 2013-02-21.
[11] C. Goble and R. Stevens. State of the nation in data integration for bioinformatics. J. of Biomedical Informatics, 41(5):687-693, 2008.
[12] L. Golab, H. Karloff, F. Korn, D. Srivastava, and B. Yu. On generating near-optimal tableaux for conditional functional dependencies. Proceedings of the VLDB Endowment (PVLDB), 1(1):376-390, 2008.
[13] G. Grahne and J. Zhu. Discovering approximate keys in XML data. In Proceedings of the International Conference on Information and Knowledge Management (CIKM), pages 453-460, 2002.
[14] D. Gunopulos, R. Khardon, H. Mannila, and R. S. Sharma. Discovering all most specific sentences. ACM Transactions on Database Systems (TODS), 28:140-174, 2003.
[15] Y. Huhtala, J. Kaerkkaeinen, P. Porkka, and H. Toivonen. Efficient discovery of functional and approximate dependencies using partitions. In Proceedings of the International Conference on Database Theory (ICDT), pages 392-401, 1998.
[16] Y. Huhtala, J. Kaerkkaeinen, P. Porkka, and H. Toivonen. TANE: an efficient algorithm for discovering functional and approximate dependencies. The Computer Journal, 42(2):100-111, 1999.
[17] IBM InfoSphere Information Analyzer. http://www-01.ibm.com/software/data/infosphere/information-analyzer.
[18] I. F. Ilyas, V. Markl, P. Haas, P. Brown, and A. Aboulnaga. CORDS: automatic discovery of correlations and soft functional dependencies. In Proceedings of the International Conference on Management of Data (SIGMOD), pages 647-658, 2004.
[19] M. Kantola, H. Mannila, K.-J. Rih, and H. Siirtola. Discovering functional and inclusion dependencies in relational databases. International Journal of Intelligent Systems, 12:591-607, 1992.
[20] Z. Lacroix and T. Critchlow. Bioinformatics: managing scientific data. Morgan Kaufmann, 2003.
[21] F. D. Marchi, S. Lopes, and J.-M. Petit. Unary and n-ary inclusion dependency discovery in relational databases. Journal of Intelligent Information Systems, 32(1):53-73, 2009.
[22] Microsoft Data Profiling Task, 03/2013. http://msdn.microsoft.com/en-us/library/bb895263.aspx.
[23] Oracle 11g Data Profiling. http://www.oracle.com/technetwork/middleware/data-integration/index-082810.html.
[24] H. Saiedian and T. Spencer. An efficient algorithm to compute the candidate keys of a relational database schema. The Computer Journal, 39(2):124-132, 1996.
[25] Y. Sismanis, P. Brown, P. J. Haas, and B. Reinwald. Gordian: efficient and scalable discovery of composite keys. In Proceedings of the International Conference on Very Large Databases (VLDB), pages 691-702, 2006.
[26] M. Stonebraker, S. Madden, D. J. Abadi, S. Harizopoulos, N. Hachem, and P. Helland. The end of an architectural era (it's time for a complete rewrite). In Proceedings of the International Conference on Very Large Databases (VLDB), pages 1150-1160, 2007.
[27] M. Zhang, M. Hadjieleftheriou, B. C. Ooi, C. M. Procopiuc, and D. Srivastava. On multi-column foreign key discovery. Proceedings of the VLDB Endowment (PVLDB), 3(1-2):805-814, 2010.

1. A method of processing data stored in a database which comprises a plurality of rows and columns, the method comprising:
A) identifying a plurality of sets of column combinations, each set of column combinations comprising an identifier of at least one column;
B) allocating each set of column combinations to one of a plurality of nodes;
C) mapping the nodes to a lattice structure in which the nodes are connected in a superset or subset relationship according to the set of column combinations of each node;
D) selecting a current node;
E) processing the data in the set of columns of the current node to detect if the column combination is unique or non-unique;
F) traversing the lattice to a next node which is connected to the current node;
G) processing the data in the set of columns of the next node to detect if the column combination of the next node is unique or non-unique; and
H) storing a record of whether each processed set of column combinations is unique or non-unique.

2. The method of claim 1, wherein the method further comprises setting the next node as the current node and repeating steps F to H for at least one further iteration.

3. The method of claim 1 or claim 2, wherein storing step H comprises only storing a record of either unique or non-unique sets of column combinations.

4. The method of any one of the preceding claims, wherein the method further comprises determining a group of sets of non-unique column combinations by subtracting the sets of unique column combinations from the total number of column combinations.

5. The method of any one of claims 1 to 3, wherein the method further comprises determining a group of sets of unique column combinations by subtracting the sets of non-unique column combinations from the total number of column combinations.

6. The method of any one of the preceding claims, wherein the method further comprises recording a list of duplicate values in each column combination in a position list index (PLI).

7. The method of claim 6, wherein the method further comprises searching the PLI for the set of column combinations of a node before processing the data in the set of columns.

8. The method of claim 7, wherein if the set of column combinations is detected in the PLI, recording the set of column combinations as a non-unique set of column combinations and traversing to the next node in the lattice without processing the data in the set of columns of the current node.

9. The method of any one of the preceding claims, wherein the method further comprises storing in a graph data structure, for a selected column, a list of sets of unique column combinations and sets of non-unique column combinations containing the selected column.

10. The method of claim 9, wherein the method further comprises searching the graph data structure for the set of column combinations of a node before processing the data in the set of column combinations to determine if a set of column combinations is a superset or subset of a set of column combinations which was previously determined to be unique or non-unique.

11. The method of any one of the preceding claims, wherein the method further comprises recording in a path trace data structure the path in which the lattice is traversed.

12. The method of any one of the preceding claims, wherein the method further comprises receiving a user input traversal parameter and the step of traversing the lattice is performed in accordance with the user input traversal parameter.

13. The method of any one of the preceding claims, wherein steps of the method are performed using a plurality of central processing unit (CPU) cores.

14. The method of claim 13, wherein steps of the method are performed by multiple worker modules with at least two worker modules executing on separate CPU cores, and wherein each worker module stores a local copy of all unique and non-unique sets of column combinations which have been already detected by the other worker modules.

15. The method of claim 14, wherein the method comprises communicating detection information between the worker modules via a shared local event bus.

16. The method of any one of the preceding claims, wherein steps of the method are performed on separate computer nodes in a network of computer nodes.

17. The method of any one of the preceding claims, wherein the method comprises recording any null values in the data as duplicates.

18. The method of any one of the preceding claims, wherein the method further comprises initially estimating the distinctness of the sets of column combinations of each node and selecting the node having the set of column combinations with the highest distinctness as the initial current node.

19. The method of any one of the preceding claims, wherein the method comprises traversing the lattice in a first direction until a node is identified with a unique set of column combinations and then traversing the lattice in a second direction until a node is detected with a non-unique set of column combinations.

20. The method of claim 19, wherein the method comprises repeating for a plurality of iterations the traversal of the lattice in the first and second directions.

21. A system for processing data stored in a database which comprises a plurality of rows and columns, the system comprising:
A) an identification module operable to identifying a plurality of sets of column combinations, each set of column combinations comprising an identifier of at least one column;
B) an allocation module operable to allocate each set of column combinations to one of a plurality of nodes;
C) a mapping module operable to map the nodes to a lattice structure in which the nodes are connected in a superset or subset relationship according to the set of column combinations of each node;
D) a selection module operable to select a current node;
E) a processing module operable to process the data in the set of columns of the current node to detect if the column combination is unique or non-unique;
F) a traversal module operable to traverse the lattice to a next node which is connected to the current node;
G) a further processing module operable to process the data in the set of columns of the next node to detect if the column combination of the next node is unique or non-unique; and
H) a memory operable to store a record of whether each processed set of column combinations is unique or non-unique.

22. The system of claim 21, wherein the system is operable to set the next node as the current node and operate the modules F to H for at least one further iteration.

23. The system of claim 21 or claim 22, wherein the storing module H is operable to only store a record of either unique or non-unique sets of column combinations.

24. The system of any one of claims 21 to 23, wherein the system is operable to determine a group of sets of non-unique column combinations by subtracting the sets of unique column combinations from the total number of column combinations.

25. The system of any one of claims 21 to 23, wherein the system is operable to determine a group of sets of unique column combinations by subtracting the sets of non-unique column combinations from the total number of column combinations.

26. The system of any one of claims 21 to 25, wherein the system is operable to record a list of duplicate values in each column combination in a position list index (PLI).

27. The system of claim 26, wherein the system is operable to search the PLI for the set of column combinations of a node before processing the data in the set of columns.

28. The system of claim 27, wherein if the set of column combinations is detected in the PLI, system is operable to record the set of column combinations as a non-unique set of column combinations and traversing to the next node in the lattice without processing the data in the set of columns of the current node.

29. The system of any one of claims 21 to 28, wherein the system is operable to store in a graph data structure, for a selected column, a list of sets of unique column combinations and sets of non-unique column combinations containing the selected column.

30. The system of claim 29, wherein the system is operable to searching the graph data structure for the set of column combinations of a node before processing the data in the set of column combinations to determine if a set of column combinations is a superset or subset of a set of column combinations which was previously determined to be unique or non-unique.

31. The system of any one of claims 21 to 30, wherein the system is operable to record in a path trace data structure the path in which the lattice is traversed.

32. The system of any one of claims 21 to 31, wherein the system is operable to receive a user input traversal parameter and the step of traversing the lattice is performed in accordance with the user input traversal parameter.

33. The system of any one of claims 21 to 32, wherein the system incorporates steps of a plurality of central processing unit (CPU) cores.

34. The system of claim 33, wherein the system incorporates multiple worker modules at least two of the worker modules are operable to execute on separate CPU cores, and wherein each worker module is operable to store a local copy of all unique and non-unique sets of column combinations which have been already detected by the other worker modules.

35. The system of claim 34, wherein the system is operable to communicate detection information between the worker modules via a shared local event bus.

36. The system of any one of claims 21 to 35, wherein the system incorporates separate computer nodes in a network of computer nodes.

37. The system of any one of claims 21 to 36, wherein the system is operable to record any null values in the data as duplicates.

38. The system of any one of claims 21 to 37, wherein the system is operable to initially estimate the distinctness of the sets of column combinations of each node and select the node having the set of column combinations with the highest distinctness as the initial current node.

39. The system of any one of claims 21 to 38, wherein the system is operable to traverse the lattice in a first direction until a node is identified with a unique set of column combinations and then traverse the lattice in a second direction until a node is detected with a non-unique set of column combinations.

40. The system of claim 39, wherein the system is operable to repeat for a plurality of iterations the traversal of the lattice in the first and second directions.
